(19) United States
(12) Patent Application Publication
(10) Pub. No.: US 2016/0111083 A1
(43) Pub. Date: Apr. 21, 2016

(54) PHONEME INFORMATION SYNTHESIS DEVICE, VOICE SYNTHESIS DEVICE, AND PHONEME INFORMATION SYNTHESIS METHOD

(71) Applicant: Yamaha Corporation, Hamamatsu-shi (JP)

(72) Inventor: Tatsuya IRIYAMA, Hamamatsu-shi (JP)

(21) Appl. No.: 14/884,633

(22) Filed: Oct. 15, 2015

(30) Foreign Application Priority Data
Oct. 15, 2014 (JP) 2014-211194

(51) Int. Cl. G10L 13/10; G10L 13/08; G10L 13/033

(52) U.S. Cl. CPC G10L 13/10; G10L 13/0335; G10L 13/08

(57) ABSTRACT

Provided is a phoneme information synthesis device, including: an operation intensity information acquisition unit configured to acquire information indicating an operation intensity; and a phoneme information generation unit configured to output phoneme information for specifying a phoneme of a singing voice to be synthesized based on the information indicating the operation intensity supplied from the operation intensity information acquisition unit.

### CROSS-REFERENCE TO RELATED APPLICATION

The present application claims priority from Japanese Application JP 2014-211194, the content to which is hereby incorporated by reference into this application.

### BACKGROUND OF THE INVENTION

1. Field of the Invention

The present invention relates to a voice synthesis technology, and more particularly, to a technology for synthesizing a singing voice in real time based on an operation of an operating element.

2. Description of the Related Art

In recent years, as voice synthesis technologies become widespread, there has been an increasing need to realize a “singing performance” by mixing a musical sound signal output by an electronic musical instrument such as a synthesizer and a singing voice signal output by a voice synthesis device to emit sound. Therefore, a voice synthesis device that employs various voice synthesis technologies has been proposed.

In order to synthesize singing voices having various phonemes and pitches, the above-mentioned voice synthesis device is required to specify the phonemes and the pitches of the singing voices to be synthesized. Therefore, in a first technology, lyric data is stored in advance, and pieces of lyric data are sequentially read based on key depressing operations, to synthesize the singing voices which correspond to phonemes indicated by the lyric data and which have pitches specified by the key depressing operations. The technology of this kind is described in, for example, Japanese Patent Application Laid-open No. 2012-083569 and Japanese Patent Application Laid-open No. 2012-083570. Further, in a second technology, each time a key depressing operation is conducted, a singing voice is synthesized so as to correspond to a specific phonetic character such as “ra” and to have a pitch specified by the key depressing operation. Further, in a third technology, each time a key depressing operation is conducted, a character is randomly selected from among a plurality of candidates provided in advance, to thereby synthesize a singing voice which corresponds to a phoneme indicated by the selected character and which has a pitch specified by the key depressing operation.

### SUMMARY OF THE INVENTION

However, the first technology requires a device capable of inputting a character, such as a personal computer. This causes the device to increase not only in size but also in cost correspondingly. Further, it is difficult for foreigners who do not understand Japanese to input lyrics in Japanese. In addition, English involves cases where the same character is pronounced as different phonemes depending on situations (for example, a phoneme “ve” is pronounced as “f” when “have” is followed by “to”). When such a word is input, it is difficult to predict whether or not the word is to be pronounced with a desired phoneme.

The second technology simply allows the same voice (for example, “ra”) to be repeated, and does not allow expressive lyrics to be generated. This forces an audience to listen to a boring sound produced by only repeating the voice of “ra”.

With the third technology, there is a fear that meaningless lyrics that are not desired by a user may be generated. Further, musical performances often involve a scene where repeatability such as “repeatedly hitting the same note” or “returning to the same melody” is wished to be added. However, in the third technology, random voices are reproduced, which gives no guarantee that the same lyrics are repeatedly reproduced.

Further, none of the first to third technologies allows an arbitrary phoneme to be determined so as to synthesize a singing voice having an arbitrary pitch in real time, which raises a problem in that an impromptu vocal synthesis is unable to be conducted.

One or more embodiments of the present invention has been made in view of the above-mentioned circumstances, and an object of one or more embodiments of the present invention is to provide a technical measure for synthesizing a singing voice corresponding to an arbitrary phoneme in real time.

In a field of jazz, there is a singing style called “scat” in which a singer sings simple words (for example, “daba daba” or “dubi dubi”) to a melody impromptu. Unlike other singing styles, the scat does not require a technology for generating a large number of meaningful words (for example, “come out, come out, cherry blossoms have come out”), but there is a demand for a technology for generating a voice desired by a performer to a melody in real time. Therefore, one or more embodiments of the present invention provides a technology for synthesizing a singing voice optimal for the scat.

According to one embodiment of the present invention, there is provided a phoneme information synthesis device, including: an operation intensity information acquisition unit configured to acquire information indicating an operation intensity; and a phoneme information generation unit configured to output phoneme information for specifying a phoneme of a singing voice to be synthesized based on the information indicating the operation intensity supplied from the operation intensity information acquisition unit.

According to one embodiment of the present invention, there is provided a phoneme information synthesis method, including: acquiring, information indicating an operation intensity; and outputting phoneme information for specifying a phoneme of a singing voice to be synthesized based on the information indicating the operation.

### BRIEF DESCRIPTION OF THE DRAWINGS

FIG. 1 is a block diagram for illustrating a configuration of a voice synthesis device 1 according to one embodiment of the present invention.

FIG. 2 is a table for showing an example of note numbers associated with respective keys of a keyboard according to the embodiment.

FIG. 3A and FIG. 3B are a table and a graph for showing an example of detection voltages output from channels 0 to 8 according to the embodiment.

FIG. 4 is a table for showing an example of a Note-On event and a Note-Off event according to the embodiment.

FIG. 5 is a block diagram for illustrating a configuration of a voice synthesis unit 130 according to the embodiment.

FIG. 6 is a table for showing an example of a lyric converting table according to the embodiment.

FIG. 7 is a flowchart for illustrating processing executed by a phoneme information synthesis section 131 and a pitch information extraction section 132 according to the embodiment.

FIG. 8A and FIG. 8B are a table and a graph for showing an example of detection voltages output from the channels 0 to 8 of the voice synthesis device 1 that supports a musical performance of a slur.

FIG. 9A, FIG. 9B, and FIG. 9C are diagrams for illustrating an effect of the voice synthesis device 1 that supports the musical performance of the slur.

FIG. 10A and FIG. 10B are a table and a graph for showing an example of detection voltages output from the respective channels when keys 150_k (k=0 to n−1) are struck with a mallet.

FIG. 11 is a graph for showing an operation pressure applied to the key 150_k (k=0 to n−1) and a volume of a voice emitted from the voice synthesis device 1.

FIG. 12 is a table for showing an example of the lyric converting table provided for the mallet.

FIG. 13 is a diagram for illustrating an example of an adjusting control used when a selection is made from the lyric converting table.

### DETAILED DESCRIPTION OF THE INVENTION

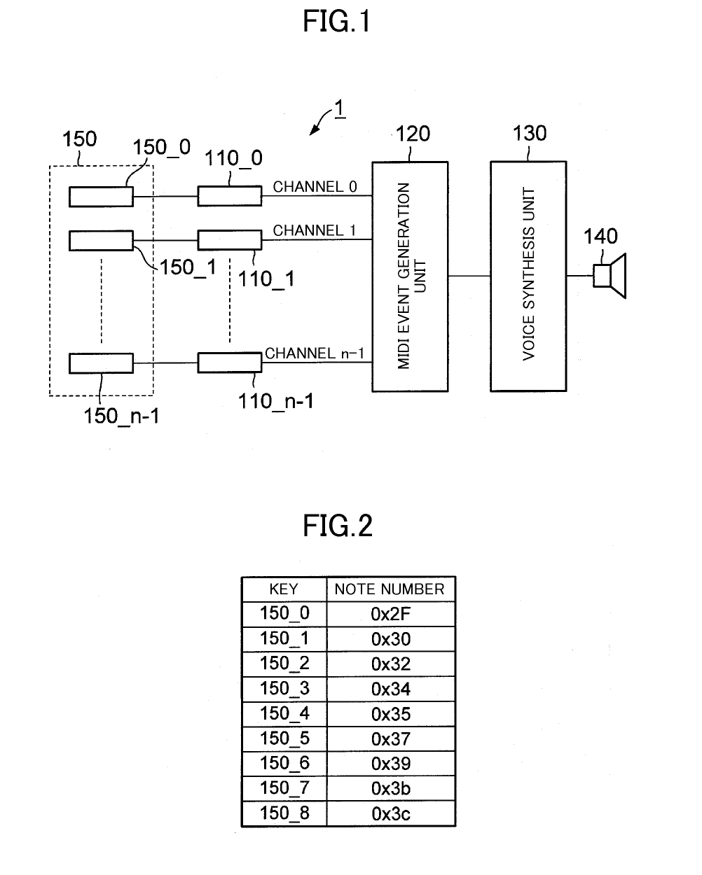

FIG. 1 is a block diagram for illustrating a configuration of a voice synthesis device 1 according to an embodiment of the present invention. As illustrated in FIG. 1, the voice synthesis device 1 includes a keyboard 150, operation intensity detection units 110_k (k=0 to n−1), a MIDI event generation unit 120, a voice synthesis unit 130, and a speaker 140.

The keyboard 150 includes n (n is plural, for example, n=88) keys 150_k (k=0 to n−1). Note numbers for specifying pitches are assigned to the keys 150_k (k=0 to n−1). To specify the pitch of a singing voice to be synthesized, a user depresses the key 150_k (k=0 to n−1) corresponding to a desired pitch. FIG. 2 is an illustration of an example of note numbers assigned to nine keys 150_0 to 150_8 among the keys 150_k (k=0 to n−1). In this example, note numbers having a MIDI format are assigned to the keys 150_k (k=0 to n−1).

The operation intensity detection units 110_k (k=0 to n−1) each output information indicating an operation intensity applied to the key 150_k (k=0 to n−1). The term “operation intensity” used herein represents an operation pressure applied to the key 150_k (k=0 to n−1) or an operation speed of the key 150_k (k=0 to n−1) at a time of being depressed. In this embodiment, the operation intensity detection units 110_k (k=0 to n−1) each output a detection signal indicating the operation pressure applied to the key 150_k (k=0 to n−1) as the operation intensity. The operation intensity detection units 110_k (k=0 to n−1) each include a pressure sensitive sensor. When one of the keys 150_k is depressed, the operation pressure applied to the one of the keys 150_k is transmitted to the pressure sensitive sensor of one of the operation intensity detection units 110_k. The operation intensity detection units 110_k each output a detection voltage corresponding to the operation pressure applied to one of the pressure sensitive sensors. Note that, in order to conduct calibration and various settings for each pressure sensitive sensor, another pressure sensitive sensor may be separately provided to the operation intensity detection unit 110_k (k=0 to n−1).

The MIDI event generation unit 120 is a device configured to generate a MIDI event for controlling synthesis of the singing voice based on the detection voltage output by the operation intensity detection unit 110_k (k=0 to n−1), and is formed of a module including a CPU and an A/D converter.

The MIDI event generated by the MIDI event generation unit 120 includes a Note-On event and a Note-Off event. A method of generating those MIDI events is as follows.

First, the respective detection voltages output by the operation intensity detection units 110_k (k=0 to n−1) are supplied to the A/D converter of the MIDI event generation unit 120 through respective channels 0 to n−1. The A/D converter sequentially selects the channels 0 to n−1 under time division control, and samples the detection voltage for each channel at a fixed sampling rate, to convert the detection voltage into a 10-bit digital value.

When the detection voltage (digital value) of a given channel k exceeds a predetermined threshold value, the MIDI event generation unit 120 assumes that Note On of the keyboard 150_k has occurred, and executes processing for generating the Note-On event and the Note-Off event.

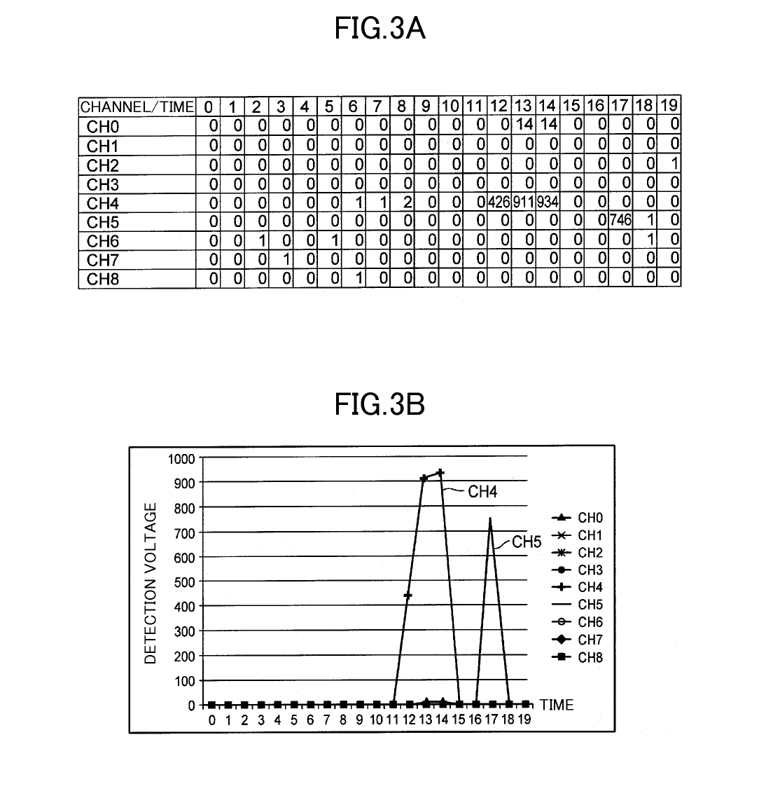

FIG. 3A is a table of an example of the detection voltages obtained through channels 0 to 8. In this example, the detection voltage A/D-converted by the A/D converter having a sampling period of 10 ms and a reference voltage of 3.3 V is indicated by the 10-bit digital value. FIG. 3B is a graph plotted based on measured values shown in FIG. 3A. A vertical axis of the graph indicates the detection voltage, and a horizontal axis thereof indicates a time.

For example, assuming that a threshold value is 500, in the example shown in FIG. 3B, the detection voltages output from the channels 4 and 5 exceed the threshold value of 500. Accordingly, the MIDI event generation unit 120 generates the Note-On event and the Note-Off event for the channels 4 and 5.

Further, when the detection voltage of the given channel k exceeds the predetermined threshold value, the MIDI event generation unit 120 sets a time at which the detection voltage reaches a peak as a Note-On time, and calculates the velocity for Note On based on the detection voltage at the Note-On time. More specifically, the MIDI event generation unit 120 calculates the velocity by using the following calculation expression. In the following expression, VEL represents the velocity, E represents the detection voltage (digital value) at the Note-On time, and k represents a conversion coefficient (where k=0.000121). The velocity VEL obtained from the calculation expression assumes a value within a range of from 0 to 127, which can be assumed by the velocity as defined in the MIDI standard.

VEL=E×E×k (1)

Further, the MIDI event generation unit 120 sets a time at which the detection voltage of the given channel k starts to drop after exceeding the predetermined threshold value and reaching the peak as a Note-Off time, and calculates the velocity for Note Off based on the detection voltage at the Note-Off time. The calculation expression for the velocity is the same as in the case of Note On.

Further, the MIDI event generation unit 120 stores a table indicating the note numbers assigned to the keys 150_k (k=0 to n−1) as shown in FIG. 2. When Note On of the key 150_k is detected based on the detection voltage of the given channel k, the MIDI event generation unit 120 refers to the table, to thereby obtain the note number of the key 150_k. Further, when Note Off of the key 150_k is detected based on the detection voltage of the given channel k, the MIDI event generation unit 120 refers to the table, to thereby obtain the note number of the key 150_k.

When Note On of the key 150_k is detected based on the detection voltage of the given channel k, the MIDI event generation unit 120 generates a Note-On event including the velocity and the note number at the Note-On time, and supplies the Note-On event to the voice synthesis unit 130. Further, when Note Off of the key 150_k is detected based on the detection voltage of the given channel k, the MIDI event generation unit 120 generates a Note-Off event including the velocity and the note number at the Note-Off time, and supplies the Note-Off event to the voice synthesis unit 130.

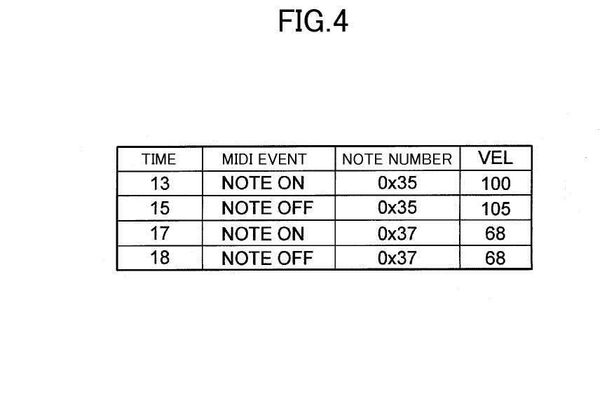

FIG. 4 is a table for showing an example of the Note-On event and the Note-Off event that are generated by the MIDI event generation unit 120. The velocities shown in FIG. 4 are generated based on the measured values of the detection voltages shown in FIG. 3B. As shown in FIG. 4, the velocity and the note number indicated by the Note-On event generated at a time 13 are 100 and 0×35, respectively. Further, the velocity and the note number indicated by the Note-Off event generated at a time 15 are 105 and 0×35, respectively. Further, the velocity and the note number indicated by the Note-On event generated at a time 17 are 68 and 0×37, respectively. Further, the velocity and the note number indicated by the Note-Off event generated at a time 18 are 68 and 0×37, respectively.

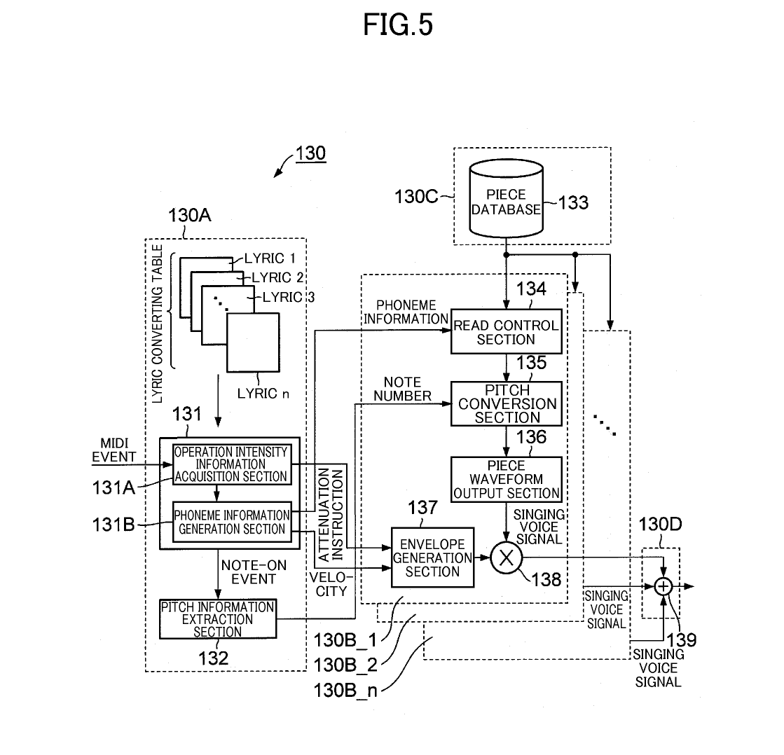

FIG. 5 is a block diagram for illustrating a configuration of the voice synthesis unit 130 according to this embodiment. The voice synthesis unit 130 is a unit configured to synthesize the singing voice which corresponds to a phoneme indicated by phoneme information obtained from the velocity of the Note-On event and which has the pitch indicated by the note number of the Note-On event. As illustrated in FIG. 5, the voice synthesis unit 130 includes a voice synthesis parameter generation section 130A, voice synthesis channels 130B_1 to 130B_n, a storage section 130C, and an output section 130D. The voice synthesis unit 130 may simultaneously synthesize n singing voice signals at maximum by using n voice synthesis channels 130B_1 to 130B_n each configured to synthesize a singing voice signal.

The voice synthesis parameter generation section 130A includes a phoneme information synthesis section 131 and a pitch information extraction section 132. The voice synthesis parameter generation section 130A generates a voice synthesis parameter to be used for synthesizing the singing voice signal.

The phoneme information synthesis section 131 includes an operation intensity information acquisition section 131A and a phoneme information generation section 131B. The operation intensity information acquisition section 131A acquires information indicating the operation intensity, that is, a MIDI event including the velocity, from the MIDI event generation unit 120. When the acquired MIDI event is the Note-On event, the operation intensity information acquisition section 131A selects an available voice synthesis channel from among the n voice synthesis channels 130B_1 to 130B_n, and assigns voice synthesis processing corresponding to the acquired Note-On event to the selected voice synthesis channel. Further, the operation intensity information acquisition section 131A stores a channel number of the selected voice synthesis channel and the note number of the Note-On event corresponding to the voice synthesis processing assigned to the voice synthesis channel, in association with each other. After executing the above-mentioned processing, the operation intensity information acquisition section 131A outputs the acquired Note-On event to the phoneme information generation section 131B.

When receiving the Note-On event from the operation intensity information acquisition section 131A, the phoneme information generation section 131B generates the phoneme information for specifying the phoneme of the singing voice to be synthesized based on the velocity (that is, operation intensity supplied to the key serving as an operating element) included in the Note-On event.

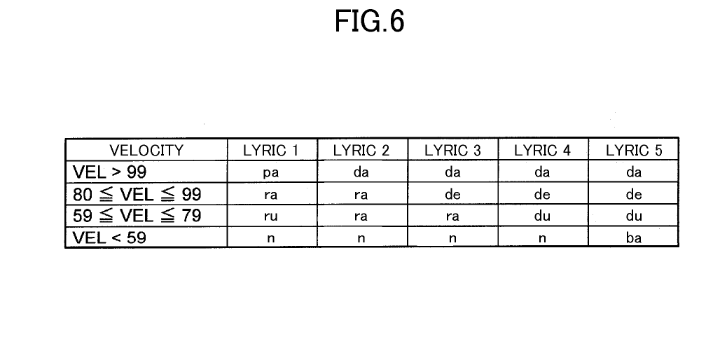

The voice synthesis parameter generation section 130A stores a lyric converting table in which the phoneme information is set for each level of the velocity in order to generate the phoneme information from the velocity of the Note-On event. FIG. 6 is a table for showing an example of the lyric converting table. As shown in FIG. 6, the velocity is segmented into four ranges of VEL<59, 59≦VEL≦79, 80≦VEL≦99, and 99<VEL depending on the level. Further, the phonemes of the singing voices to be synthesized are set for the four ranges. Further, the phonemes set for the respective ranges differ among a lyric 1 to a lyric 5. The lyric 1 to the lyric 5 are provided for different genres of songs, and the phonemes that are most suitable for use in the song of each of the genres are included in each of the lyric 1 to the lyric 5. For example, the lyric 5 includes the phonemes such as “da”, “de”, “du”, and “ba” that give relatively strong impressions, and is desired to be used in performing jazz. Further, the lyric 2 includes the phonemes such as “da”, “ra”, “ra”, and “n” that give relatively soft impressions, and is desired to be used in performing ballad.

In a preferred mode, the voice synthesis device 1 is provided with an adjusting control or the like for selecting the lyric so as to allow the user to appropriately select which lyric to apply from among the lyric 1 to the lyric 5. In this mode, when the lyric 1 is selected by the user, the phoneme information generation section 131B of the voice synthesis parameter generation section 130A outputs the phoneme information for specifying “n” when VEL<59 is satisfied by the velocity VEL extracted from the Note-On event, the phoneme information for specifying “ru” when 59≦VEL≦79 is satisfied by the velocity VEL, the phoneme information for specifying “ra” when 80≦VEL≦99 is satisfied by the velocity VEL, and the phoneme information for specifying “pa” when VEL>99 is satisfied by the velocity VEL. When the phoneme information is thus obtained from the Note-On event, the phoneme information generation section 131B outputs the phoneme information to a read control section 134 of the voice synthesis channel to which the voice synthesis processing corresponding to the Note-On event is assigned.

Further, when extracting the velocity from the Note-On event, the phoneme information generation section 131B outputs the velocity to an envelope generation section 137 of the voice synthesis channel to which the voice synthesis processing corresponding to the Note-On event is assigned.

When receiving the Note-On event from the phoneme information generation section 131B, the pitch information extraction section 132 extracts the note number included in the Note-On event, and generates pitch information for specifying the pitch of the singing voice to be synthesized. When extracting the note number, the pitch information extraction section 132 outputs the note number to a pitch conversion section 135 of the voice synthesis channel to which the voice synthesis processing corresponding to the Note-On event is assigned.

The configuration of the voice synthesis parameter generation section 130A has been described above.

The storage section 130C includes a piece database 133. The piece database 133 is an aggregate of phonetic piece data indicating waveforms of various phonetic pieces serving as materials for a singing voice such as a transition part from a silence to a consonant, a transition part from a consonant to a vowel, a stretched sound of a vowel, and a transition part from a vowel to a silence. The piece database 133 stores piece data required to generate the phoneme indicated by the phoneme information.

The voice synthesis channels 130B_1 to 130B_n each include the read control section 134, the pitch conversion section 135, a piece waveform output section 136, the envelope generation section 137, and a multiplication section 138. Each of the voice synthesis channels 130B_1 to 130B_n synthesizes the singing voice signal based on the voice synthesis parameters such as the phoneme information, the note number, and the velocity that are acquired from the voice synthesis parameter generation section 130A. In the example illustrated in FIG. 5, the illustration of the voice synthesis channels 130B_2 to 130B_n is simplified in order to prevent the figure from being complicated. However, in the same manner as the voice synthesis channel 130B_1, each of those voice synthesis channels also synthesizes the singing voice signal based on the various voice synthesis parameters acquired from the voice synthesis parameter generation section 130A. Various kinds of processing executed by the voice synthesis channels 130B_1 to 130B_n may be executed by the CPU, or may be executed by hardware provided separately.

The read control section 134 reads, from the piece database 133, the piece data corresponding to the phoneme indicated by the phoneme information supplied from the phoneme information generation section 131B, and outputs the piece data to the pitch conversion section 135.

When acquiring the piece data from the read control section 134, the pitch conversion section 135 converts the piece data into piece data (sample data having a piece waveform subjected to the pitch conversion) having the pitch indicated by the note number supplied from the pitch information extraction section 132. Then, the piece waveform output section 136 smoothly connects pieces of piece data, which are generated sequentially by the pitch conversion section 135, along a time axis, and outputs the piece data to the multiplication section 138.

The envelope generation section 137 generates the sample data having an envelope waveform of the singing voice signal to be synthesized based on the velocity acquired from the phoneme information generation section 131B, and outputs the sample data to the multiplication section 138.

The multiplication section 138 multiplies the piece data supplied from the piece waveform output section 136 by the sample data having the envelope waveform supplied from the envelope generation section 137, and outputs a singing voice signal (digital signal) serving as a multiplication result to the output section 130D.

The output section 130D includes an adder 139, and when receiving the singing voice signals from the voice synthesis channels 130B_1 to 130B_n, adds the singing voice signals to one another. A singing voice signal serving as an addition result is converted into an analog signal by a D/A converter (not shown), and emitted as a voice from the speaker 140.

On the other hand, when receiving the Note-Off event from the MIDI event generation unit 120, the operation intensity information acquisition section 131A extracts the note number from the Note-Off event. Then, the operation intensity information acquisition section 131A identifies the voice synthesis channel to which the voice synthesis processing for the extracted note number is assigned, and transmits an attenuation instruction to the envelope generation section 137 of the voice synthesis channel. This causes the envelope generation section 137 to attenuate the envelope waveform to be supplied to the multiplication section 138. As a result, the singing voice signal stops being output through the voice synthesis channel.

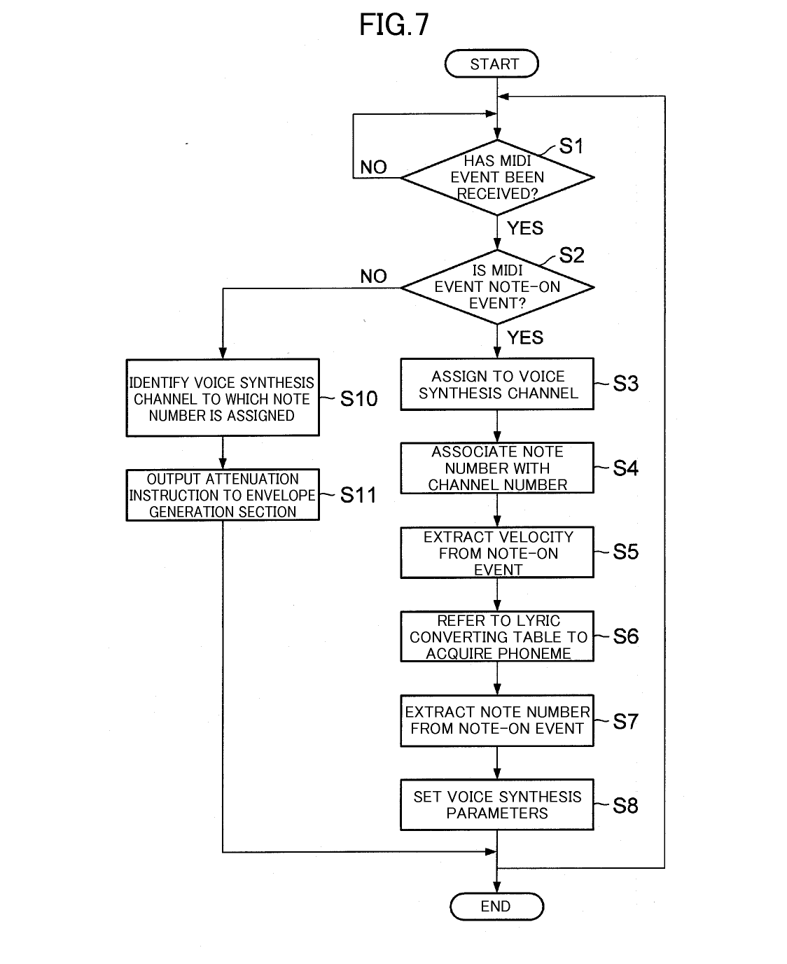

FIG. 7 is a flowchart for illustrating processing executed by the phoneme information synthesis section 131 and the pitch information extraction section 132. The operation intensity information acquisition section 131A determines whether or not the MIDI event has been received from the MIDI event generation unit 120 (Step S1), and repeats the above-mentioned determination until the determination results in “YES”.

When the determination of Step S1 results in “YES”, the operation intensity information acquisition section 131A determines whether or not the MIDI event is the Note-On event (Step S2). When the determination of Step S2 results in “YES”, the operation intensity information acquisition section 131A selects an available voice synthesis channel from among the voice synthesis channels 130B_1 to 130B_n, and assigns the voice synthesis processing corresponding to the acquired Note-On event to the voice synthesis channel (Step S3). Further, the operation intensity information acquisition section 131A associates the note number included in the acquired Note-On event with the channel number of the selected one of the voice synthesis channels 130B_1 to 130B_n (Step S4). After the processing of Step S4 is completed, the operation intensity information acquisition section 131A supplies the Note-On event to the phoneme information generation section 131B. When receiving the Note-On event from the operation intensity information acquisition section 131A, the phoneme information generation section 131B extracts the velocity from the Note-On event (Step S5). Then, the phoneme information generation section 131B refers to the lyric converting table to acquire the phoneme information corresponding to the velocity (Step S6).

After the processing of Step S6 is completed, the pitch information extraction section 132 acquires the Note-On event from the phoneme information generation section 131B, and extracts the note number from the Note-On event (Step S7).

As the voice synthesis parameters, the phoneme information generation section 131B outputs the phoneme information and the velocity that are obtained as described above to the read control section 134 and the envelope generation section 137, respectively, and the pitch information extraction section 132 outputs the note number obtained as described above to the pitch conversion section 135 (Step S8). After the processing of Step S8 is completed, the procedure returns to Step S1, to repeat the processing of Steps S1 to S8 described above.

On the other hand, when the Note-Off event is received as the MIDI event, the determination of Step S1 results in “YES”, the determination of Step S2 results in “NO”, and the procedure advances to Step S10. In Step S10, the operation intensity information acquisition section 131A extracts the note number from the Note-Off event, and identifies the voice synthesis channel to which the voice synthesis processing for the extracted note number is assigned (Step S10). Then, the operation intensity information acquisition section 131A outputs the attenuation instruction to the envelope generation section 137 of the voice synthesis channel (Step S11).

According to the voice synthesis device 1 of this embodiment, when supplied with the Note-On event through the depressing of the key 150_k, the phoneme information synthesis section 131 of the voice synthesis unit 130 extracts the velocity indicating the operation intensity applied to the key 150_k from the Note-On event, and generates the phoneme information indicating the phoneme of the singing voice to be synthesized based on the level of the velocity. This allows the user to arbitrarily change the phoneme of the singing voice to be synthesized by appropriately adjusting the operation intensity of the depressing operation applied to the key 150_k (k=0 to n−1).

Further, according to the voice synthesis device 1, the phoneme of the voice to be synthesized is determined after the user starts the depressing operation of the key 150_k (k=0 to n−1). That is, the user has room to select the phoneme of the voice to be synthesized until immediately before depressing the key 150_k (k=0 to n−1). Accordingly, the voice synthesis device 1 enables a highly improvisational singing voice to be provided, which can meet a need of a user who wishes to perform a scat.

Further, according to the voice synthesis device 1, the lyric converting table is provided with the lyrics corresponding to musical performance of various genres such as jazz and ballad. This allows the user to provide audience with a singing voice that sounds comfortable to their ears by appropriately selecting the lyrics corresponding to the genre performed by the user himself/herself.

### Other Embodiments

The embodiment of the present invention has been described above, but other embodiments are conceivable for the present invention. Examples thereof are as follows.

(1) In the example shown in FIG. 3B, the key 150_4 is first depressed, and after the key 150_4 is released, the key 150_5 is depressed. However, in keyboard performance, succeeding Note On does not always occur after Note Off paired with preceding Note On occurs in the above-mentioned manner. For example, in a case where a slur is performed as an example of articulation, another key is depressed after a given key is depressed and before the given key is released. In this manner, in a case where there is an overlap between a period of the key depressing operation for outputting preceding phoneme information and a period of the key depressing operation for outputting succeeding phoneme information, expressive singing is realized when the singing voice emitted based on the depressing of the first depressed key is smoothly connected to the singing voice emitted based on the depressing of the key depressed after that. Therefore, in the above-mentioned embodiment, when another key is depressed after a given key is depressed and before the given key is released, the phoneme information synthesis section 131 may output the phoneme information indicating the phoneme, which is obtained by omitting a consonant from the phoneme indicated by the phoneme information generated based on the velocity of the preceding Note-On event, as the phoneme information corresponding to succeeding Note-On event. With this configuration, the phoneme of the voice emitted first is smoothly connected to the phoneme of the voice emitted later, which realizes a slur.

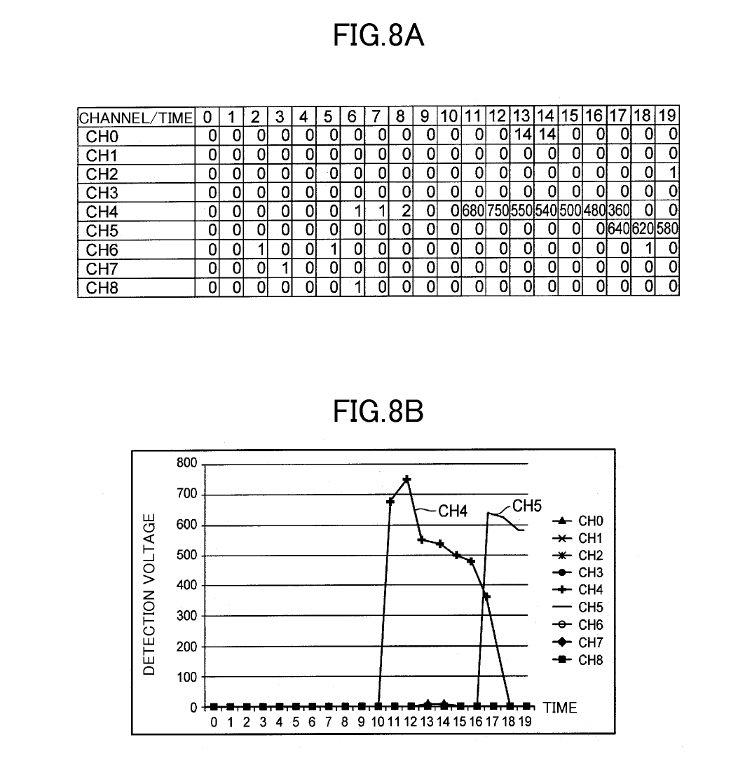

FIG. 8A and FIG. 8B are a table and a graph for showing an example of the detection voltages output from the respective channels of the voice synthesis device 1 that supports the musical performance of the slur. In this example, as shown in FIG. 8B, the detection voltage of the channel 5 rises before the detection voltage of the channel 4 attenuates. For this reason, the Note-On event of the key 150_5 occurs before the Note-Off event of the key 150_4 occurs.

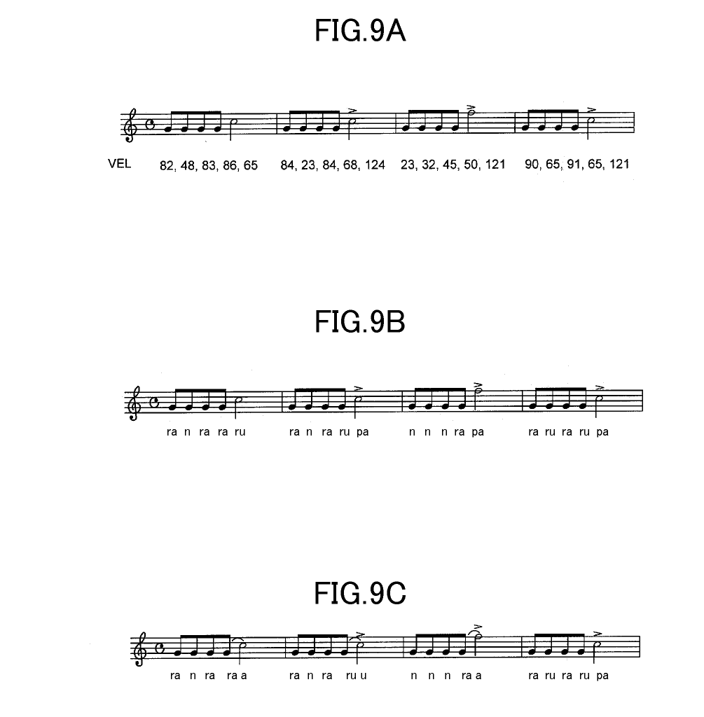

FIG. 9A, FIG. 9B, and FIG. 9C are diagrams for illustrating musical notations indicating the pitches of the singing voices to be emitted by the voice synthesis device 1. However, only the musical notation illustrated in FIG. 9C includes slurred notes. Further, the velocities are illustrated in FIG. 9A. The phoneme information synthesis section 131 determines the phonemes of the singing voices to be synthesized based on those velocities. Based on the velocities illustrated in FIG. 9A, the phonemes of the voices to be synthesized by the voice synthesis device 1 are illustrated in FIG. 9B and FIG. 9C. In comparison between FIG. 9B and FIG. 9C, notes that are not slurred are accompanied with the same phonemes of the singing voices to be synthesized in both FIG. 9B and FIG. 9C. On the other hand, the slurred notes are accompanied with different phonemes of the voices to be synthesized. More specifically, as illustrated in FIG. 9C, with the slurred notes, the phoneme of the voice emitted first is smoothly connected to the phoneme of the voice emitted later as a result of omitting the consonant of the phoneme of the voice to be emitted later. For example, when the musical performance of the slur is not conducted, the singing voice is emitted as “ra n ra ra ru” as illustrated in FIG. 9B, and when the musical performance of the slur is conducted for a note corresponding to the second last “ra” in the same part and a note corresponding to the last “ru”, the phoneme information indicating a phoneme “a”, which is obtained by omitting the consonant from a phoneme “ra” indicated by the phoneme information generated based on the velocity of the preceding Note-On event, is output as the phoneme information corresponding to succeeding Note On. For this reason, as illustrated in FIG. 9C, the singing is conducted as “ra n ra ra a”.

(2) In the above-mentioned embodiment, the key 150_k (k=0 to n−1) is depressed with a finger, to thereby apply the operation pressure to the pressure sensitive sensor included in the operation intensity detection unit 110_k (k=0 to n−1). However, for example, the voice synthesis device 1 may be provided to a mallet percussion instrument such as a glockenspiel or a xylophone, to thereby apply the operation pressure obtained when the key 150_k (k=0 to n−1) is struck with a mallet to the pressure sensitive sensor included in the operation intensity detection unit 110_k (k=0 to n−1). However, in this case, attention is required to be paid to the following two points.

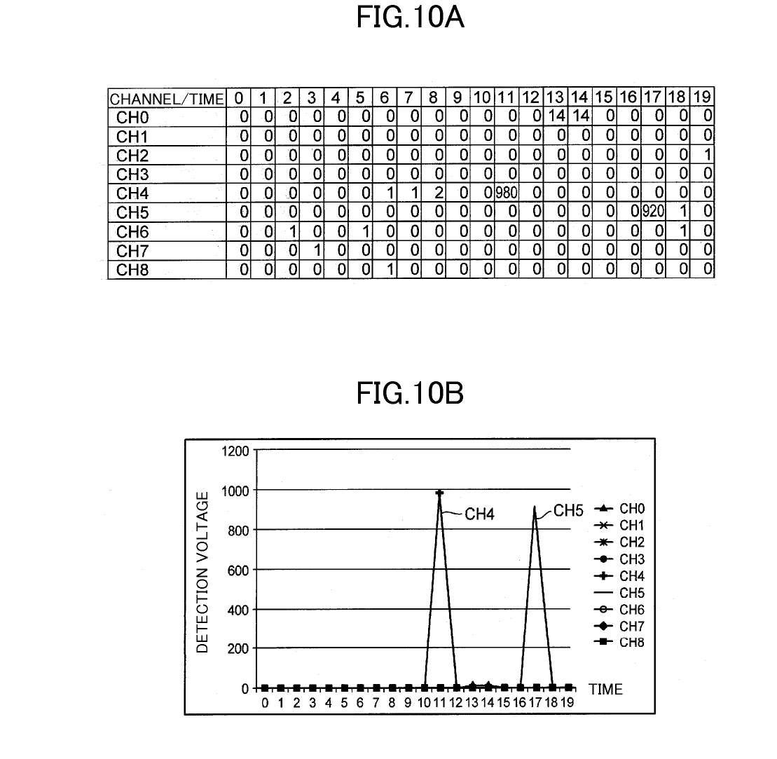

First, a time period during which the pressure sensitive sensor is depressed becomes shorter in a case where the key 150_k (k=0 to n−1) is struck with the mallet to apply the operation pressure to the pressure sensitive sensor than in a case where the key 150_k (k=0 to n−1) is depressed with the finger. For this reason, a time period from Note On until Note Off becomes shorter, and the voice synthesis device 1 may emit the singing voice only for a short time period. FIG. 10A and FIG. 10B are a table and a graph for showing an example of the detection voltages output from the respective channels when the keys 150_k (k=0 to n−1) are struck with the mallet. In this example, as shown in FIG. 10B, in both the channels 4 and 5, a change in the operation pressure due to the striking is completed for approximately 20 milliseconds. Accordingly, a time period that allows the voice synthesis device 1 to emit the singing voice is approximately 20 milliseconds unless any countermeasure is taken.

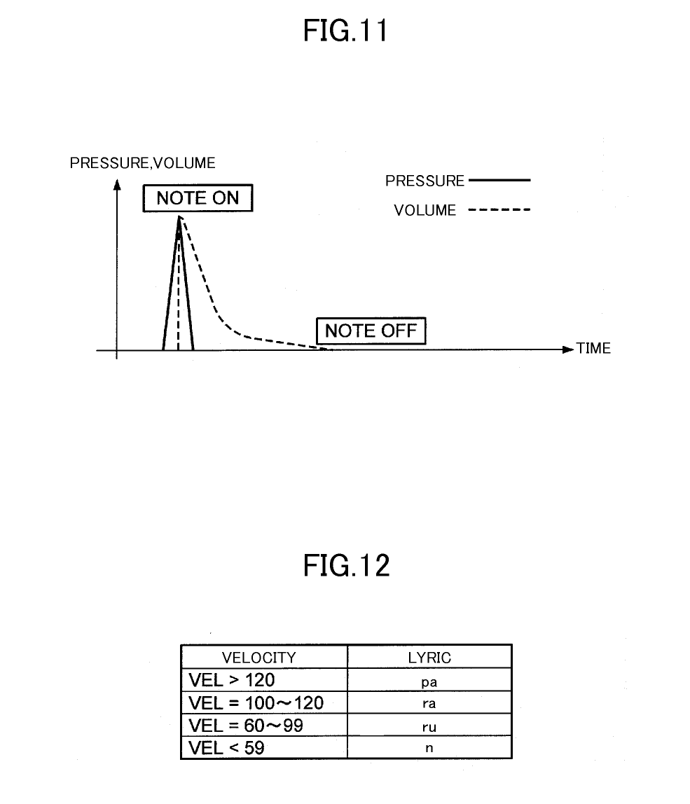

Therefore, in order to cause the voice synthesis device 1 to emit the voice for a longer time period, the configuration of the MIDI event generation unit 120 is changed so as to generate the Note-On event when the operation pressure due to the striking exceeds a threshold value and to generate the Note-Off event with a delay by a predetermined time period after the operation pressure falls below the threshold value. FIG. 11 is a graph for showing the operation pressure applied to the pressure sensitive sensor and a volume of the voice emitted from the voice synthesis device 1. As illustrated in FIG. 11, the Note-Off event occurs after a sufficient time period has elapsed since the Note-On event occurs, and hence it is understood that the volume is sustained for a while without attenuating quickly even when the operation pressure is changed quickly.

Next, in the case where the key 150_k (k=0 to n−1) is struck with the mallet, an instantaneously higher operation pressure tends to be applied to the pressure sensitive sensor than in the case where the key 150_k (k=0 to n−1) is depressed with the finger. This tends to increase the value of the detection voltage detected by the operation intensity detection unit 110_k (k=0 to n−1), to calculate the velocity having a large value. As a result, the phoneme of the voice emitted from the voice synthesis device 1 is more likely to become “pa” or “da” determined as the phonemes of the voice to be synthesized when the velocity is large.

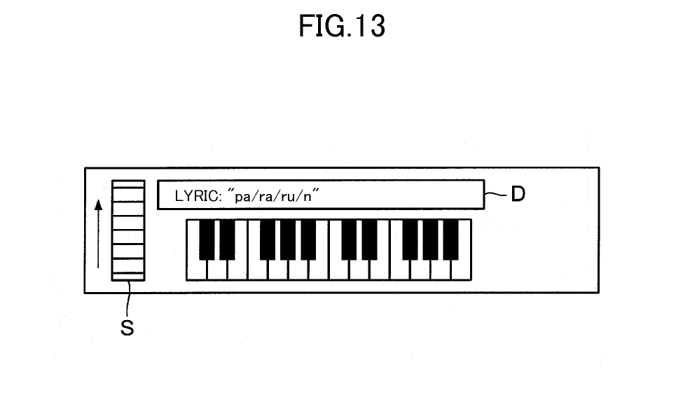

Therefore, setting values of the velocities in the lyric converting table shown in FIG. 6 are changed to separately create a lyric converting table for the mallet. FIG. 12 is a table for showing an example of the lyric converting table created for the mallet. In the lyric converting table shown in FIG. 12, the setting values of the velocities for phonemes “pa” and “ra” are larger than in the lyric converting table shown in FIG. 6. In this manner, the setting values of the velocities for the phonemes “pa” and “ra” are set larger, to thereby forcedly reduce a chance that the phonemes “pa” and “ra” are determined as the phonemes of the voices to be synthesized by the phoneme information synthesis section 131. Note that, the voice synthesis device 1 may be provided with an adjusting control or the like for selecting the lyric converting table so as to allow the user to appropriately select between the lyric converting table for the mallet and the normal lyric converting table. Further, instead of changing the setting value of the velocity within the lyric converting table, the above-mentioned calculation expression for the velocity may be changed so as to reduce the value of the velocity to be calculated.

(3) In the above-mentioned embodiment, the operation pressure is detected by the pressure sensitive sensor provided to the operation intensity detection unit 110_k (k=0 to n−1). Then, the velocity is obtained based on the operation pressure detected by the pressure sensitive sensor. However, the operation intensity detection unit 110_k (k=0 to n−1) may detect the operation speed of the key 150_k (k=0 to n−1) at the time of being depressed as the operation intensity. In this case, for example, each of the keys 150_k (k=0 to n−1) may be provided with a plurality of contacts configured to be turned on at mutually different key depressing depths, and a difference in time to be turned on between two of those contacts may be used to obtain the velocity indicating the operation speed of the key (key depressing speed). Alternatively, such a plurality of contacts and the pressure sensitive sensor may be used in combination to measure both the operation speed and the operation pressure, and the operation speed and the operation pressure may be subjected to, for example, weighting addition, to thereby calculate the operation intensity and output the operation intensity as the velocity.

(4) As the phoneme of the voice to be synthesized, a phoneme that does not exist in Japanese may be set in the lyric converting table. For example, an intermediate phoneme between “a” and “i”, an intermediate phoneme between “a” and “u”, or an intermediate phoneme between “da” and “di”, which is pronounced in English or the like, may be set. This allows the user to be provided with the expressive voice.

(5) In the above-mentioned embodiment, the keyboard is used as a unit configured to acquire the operation pressure from the user. However, the unit configured to acquire the operation pressure from the user is not limited to the keyboard. For example, a foot pressure applied to a foot pedal of an Electone may be detected as the operation intensity, and the phoneme of the voice to be synthesized may be determined based on the detected operation intensity. In addition, a contact pressure applied to a touch panel by a finger, a grasping power of a hand grasping an operating element such as a ball, or a pressure of a breath blown into a tube-like object may be detected as the operation intensity, and the phoneme of the voice to be synthesized may be determined based on the detected operation intensity.

(6) A unit configured to set the genre of a song set in the lyric converting table and to allow the user to visually recognize the phoneme of the voice to be synthesized may be provided. FIG. 13 is a diagram for illustrating an example of the adjusting control used when a selection is made from the lyric converting table. As illustrated in FIG. 13, the voice synthesis device 1 includes an adjusting control S for making a selection from the genres of the songs (lyric 1 to lyric 5) and a display screen D configured to display the genre of the song selected by using the adjusting control S and the phoneme of the voice to be synthesized. This allows the user to set the genre of the song by rotating the adjusting control and to visually recognize the set genre of the song and the phoneme of the voice to be synthesized.

(7) The voice synthesis device 1 may include a communication unit configured to connect to a communication network such as the Internet. This allows the user to distribute the voice synthesized by using the voice synthesis device 1 through the Internet so as to be able to distribute the voice to a large number of listeners. In this case, the listeners increase in number when the synthesized voice matches the listeners' preferences, while the listeners decrease in number when the synthesized voice does not match the listeners' preferences. Therefore, the values of the phonemes within the lyric converting table may be changed depending on the number of listeners. This allows the voice to be provided so as to meet the listeners' desires.

(8) The voice synthesis unit 130 may not only determine the phoneme of the voice to be synthesized based on the level of the velocity, but also determine the volume of the voice to be synthesized. For example, a sound of “n” is generated with an extremely low volume when the velocity has a small value (for example, 10), while a sound of “pa” is generated with an extremely high volume when the velocity has a large value (for example, 127). This allows the user to obtain the expressive voice.

(9) In the above-mentioned embodiment, the operation pressure generated when the user depresses the key 150_k (k=0 to n−1) with his/her finger is detected by the pressure sensitive sensor, and the velocity is calculated based on the detected operation pressure. However, the velocity may be calculated based on a contact area between the finger and the key 150_k (k=0 to n−1) obtained when the user depresses the key 150_k (k=0 to n−1). In this case, the contact area becomes large when the user depresses the key 150_k (k=0 to n−1) hard, while the contact area becomes small when the user depresses the key 150_k (k=0 to n−1) softly. In this manner, there is a correlation between the operation pressure and the contact area, which allows the velocity to be calculated based on a change amount of the contact area.

In a case where the velocity is calculated by using the above-mentioned method, a touch panel may be used in place of the key 150_k (k=0 to n−1), to calculate the velocity based on the contact area between the finger and the touch panel and a rate of change thereof.

(10) A position sensor may be provided to each portion of the key 150_k (k=0 to n−1). For example, the position sensors are arranged on a front side and a back side of the key 150_k (k=0 to n−1). In this case, the voice of “da” or “pa” that gives a strong impression may be emitted when the user depresses the key 150_k (k=0 to n−1) on the front side, while the voice of “ra” or “n” that gives a soft impression may be emitted when the user depresses the key 150_k (k=0 to n−1) on the back side. This enables an increase in variation of the voice to be emitted by the voice synthesis device 1.

(11) In the above-mentioned embodiment, the voice synthesis unit 130 includes the phoneme information synthesis section 131, but a phoneme information synthesis device may be provided as an independent device configured to output the phoneme information for specifying the phoneme of the singing voice to be synthesized based on the operation intensity with respect to the operating element. For example, the phoneme information synthesis device may receive the MIDI event from a MIDI instrument, generate the phoneme information from the velocity of the Note-On event of the MIDI event, and supply the phoneme information to a voice synthesis device along with the Note-On event. This mode also produces the same effects as the above-mentioned embodiment.

(12) The voice synthesis device 1 according to the above-mentioned embodiment may be provided to an electronic keyboard instrument or an electronic percussion so that the function of the electronic keyboard instrument or the electronic percussion may be switched between a normal electronic keyboard instrument or a normal electronic percussion and the voice synthesis device for singing a scat. Note that, in a case where the electronic percussion is provided with the voice synthesis device 1, the user may be allowed to perform electronic percussion parts corresponding to a plurality of lyrics at a time by providing an electronic percussion part corresponding to the lyric 1, an electronic percussion part corresponding to the lyric 2, . . . , and an electronic percussion part corresponding to a lyric n.

(13) In the above-mentioned embodiment, as shown in FIG. 6, the velocity is segmented into four ranges depending on the level, and the phoneme is set for each segment range. Then, in order to specify a desired phoneme, the user adjusts the operation pressure so as to fall within the range of the velocity corresponding to the phoneme. However, the number of ranges for segmenting the velocity is not limited to four, and may be appropriately changed. For example, for a user who is unfamiliar with an operation of this device, the velocity is desired to be segmented into two or three ranges depending on the level. This saves the user the need to finely adjust the operation pressure. On the other hand, for a user experienced in the operation, the velocity is desired to be segmented into a larger number of ranges. This is because, as the number of ranges for segmenting the velocity increases, the number of phonemes to be set also increases, which allows the user to specify a larger number of phonemes.

Further, the setting value of the velocity may be changed for each lyric. That is, the velocity is not required to be segmented into the ranges of VEL<59, 59≦VEL≦79, 80≦VEL≦99, and 99<VEL for every lyric, and the threshold values by which to segment the velocity into the ranges may be changed for each lyric.

Further, five kinds of lyrics, that is, the lyric 1 to the lyric 5, are set in the lyric converting table shown in FIG. 6, but a larger number of lyrics may be set.

(14) In the above-mentioned embodiment, as shown in FIG. 6, the phonemes included in the 50-character Japanese syllabary are set in the lyric converting table, but phonemes that are not included in the 50-character Japanese syllabary may be set. For example, a phoneme that does not exist in Japanese or an intermediate phoneme between two phonemes (phoneme obtained by morphing two phonemes) may Examples of the latter include the following mode. First, it is assumed that the phoneme “pa” is set for a range of VEL≧99, the phoneme “ra” is set for a range of VEL=80, and a phoneme “n” is set for a range of VEL≦49. In this case, when the velocity VEL falls within the range of 99>VEL>80, an intermediate phoneme obtained by mixing the phoneme “pa” having an intensity corresponding to a distance from a threshold value of 99 for the velocity VEL and the phoneme “ra” having an intensity corresponding to a distance from a threshold value of 80 for the velocity VEL is set as the phoneme of a synthesized sound. Further, when the velocity VEL falls within the range of 80>VEL>49, an intermediate phoneme obtained by mixing the phoneme “ra” having an intensity corresponding to a distance from the threshold value of 80 for the velocity VEL and the phoneme “n” having an intensity corresponding to a distance from a threshold value of 49 for the velocity VEL is set as the phoneme of the synthesized sound. According to this mode, the phoneme is allowed to be smoothly changed by gradually changing the operation intensity.

Examples of the latter also include another mode as follows. In the same manner as in the above-mentioned mode, it is assumed that the phoneme “pa” is set for the range of VEL≧99, the phoneme “ra” is set for the range of VEL=80, and the phoneme “n” is set for the range of VEL≦49. In this case, when the velocity VEL falls within the range of 99>VEL>80, an intermediate phoneme obtained by mixing the phoneme “pa” and the phoneme “ra” with a predetermined intensity ratio is set as the phoneme of the synthesized sound. Further, when the velocity VEL falls within the range of 80>VEL>49, an intermediate phoneme obtained by mixing the phoneme “ra” and the phoneme “n” with a predetermined intensity ratio is set as the phoneme of the synthesized sound. This mode is advantageous in that an amount of computation is small.

(15) The phoneme information synthesis device according to the above-mentioned embodiment may be provided to a server connected to a network, and a terminal such as a personal computer connected to the network may use the phoneme information synthesis device included in the server, to convert the information indicating the operation intensity into the phoneme information. Alternatively, the voice synthesis device including the phoneme information synthesis device may be provided to the server, and the terminal may use the voice synthesis device included in the server.

(16) The present invention may also be carried out as a program for causing a computer to function as the phoneme information synthesis device or the voice synthesis device according to the above-mentioned embodiment. Note that, the program may be recorded on a computer-readable recording medium.

The present invention is not limited to the above-mentioned embodiment and modes, and may be replaced by a configuration substantially the same as the configuration described above, a configuration that produces the same operations and effects, or a configuration capable of achieving the same object. For example, the configuration based on MIDI is described above as an example, but the present invention is not limited thereto, and a different configuration may be employed as long as the phoneme information for specifying the singing voice to be synthesized based on the operation intensity is output. Further, the case of using the mallet percussion instrument is described in the above-mentioned item (2) as an example, but the present invention may be applied to a percussion instrument that does not include a key.

According to one or more embodiments of the present invention, for example, the phoneme information for specifying the phoneme of the singing voice to be synthesized based on the operation intensity is output. Accordingly, the user is allowed to arbitrarily change the phoneme of the singing voice to be synthesized by appropriately adjusting the operation intensity.

What is claimed is:

1. A phoneme information synthesis device, comprising:
an operation intensity information acquisition unit configured to acquire information indicating an operation intensity; and
a phoneme information generation unit configured to output phoneme information for specifying a phoneme of a singing voice to be synthesized based on the information indicating the operation intensity supplied from the operation intensity information acquisition unit.

2. The phoneme information synthesis device according to claim 1, wherein:
the phoneme information is associated with the information indicating the operation intensity; and
the phoneme information generation unit is further configured to output, when acquiring the information indicating the operation intensity from the operation intensity information acquisition unit, the phoneme information associated with the information indicating the operation intensity.

3. The phoneme information synthesis device according to claim 1, wherein the phoneme information generation unit is further configured to output, when an operation of an operating element for outputting two pieces of phoneme information in succession is conducted with an overlap between a period of the operation of the operating element for outputting preceding phoneme information and a period of the operation of the operating element for outputting succeeding phoneme information, the phoneme information indicating a phoneme, which is obtained by omitting a consonant from the phoneme indicated by the preceding phoneme information, as the succeeding phoneme information.

4. A voice synthesis device, comprising a voice synthesis unit configured to synthesize a singing voice which corresponds to a phoneme indicated by phoneme information output by the phoneme information synthesis device of claim 1 and which has a pitch specified by an operation of an operating element.

5. The voice synthesis device according to claim 4, further comprising a keyboard as the operating element.

6. The phoneme information synthesis device according to claim 1, wherein the operation intensity information acquisition unit is further configured to acquire the information indicating the operation intensity based on a time at which a signal corresponding to an operation pressure applied to an operating element reaches a peak after exceeding a predetermined threshold value.

7. The phoneme information synthesis device according to claim 6, wherein the operation intensity information acquisition unit is further configured to stop outputting the synthesized singing voice when a signal corresponding to an operation pressure applied to the operating element starts to drop after reaching a peak.

8. The phoneme information synthesis device according to claim 6, wherein the operation intensity information acquisition unit is further configured to stop outputting the synthesized singing voice after a predetermined period has elapsed since a signal corresponding to an operation pressure applied to the operating element falls below a predetermined threshold value after exceeding the predetermined threshold value.

9. The phoneme information synthesis device according to claim 1, wherein the phoneme information comprises a phoneme included in one phoneme group selected from among a plurality of phoneme groups.

10. The phoneme information synthesis device according to claim 9, further comprising a display unit configured to display the phoneme included in one of the plurality of phoneme groups.

11. The phoneme information synthesis device according to claim 1, wherein the operation intensity comprises one of an operation pressure applied to an operating element and an operation speed of the operating element at a time of being operated.

12. The phoneme information synthesis device according to claim 1, wherein the operation intensity is acquired based on one of a pressure of a breath blown into a tube and a pressure applied to the operating element with one of a foot, a hand, and a finger.

13. A phoneme information synthesis method, comprising:
acquiring information indicating an operation intensity; and
outputting phoneme information for specifying a phoneme of a singing voice to be synthesized based on the information indicating the operation intensity.
